(19) United States
(12) Patent Application Publication
(10) Pub. No.: US 2009/0251310 A1
(43) Pub. Date: Oct. 8, 2009

(54) SYSTEM AND METHOD FOR AUDIBLY REPRESENTING A REMOTE EVENT

(76) Inventor: L. Scott Bloebaum, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/098,587

(22) Filed: Apr. 7, 2008

(51) Int. Cl. H04Q 7/00

(52) U.S. Cl. 340/539.11

(57) ABSTRACT

A system and method of audibly representing a remote event that is typically associated with a sound are used to enhance a person's experience with the event. In particular, the technique uses a portable electronic device, such as a mobile telephone, to enhance the user's auditory perception of an event that is associated with a sound, but where the user may be too far away from the source of the sound to hear the sound as it is generated by the source. The user may set a sound producing device to send a notice to the user's electronic device when the sound-generating event has occurred. The notice may be a message, or other data object, that is transmitted through a network. Upon receipt of the notice, the electronic device may play back an audio file that contains sound data representative of the sound-generating event.

### TECHNICAL FIELD OF THE INVENTION

The technology of the present disclosure relates generally to electronic devices and, more particularly, to a system and method for augmenting an audio-based event by representing the event remotely with an electronic device.

### BACKGROUND

In some circumstances, a person may be interested to know when an event has occurred. Many events are associated with an audible sound to notify the user of the event. For example, a microwave oven may generate a “beeping” sound upon the completion of a cooking process. But there may be situations in which the person moves far enough away from the source of the sound so that the person may not hear the audible sound when it is generated.

### SUMMARY

To enhance a person's experience with a sound-generating event, the present disclosure describes a system and method of audibly representing a remote event that is typically associated with a sound. As will become more apparent with the following description, the system and method may be used as an “augmented reality” (AR) technique whereby a person's real-world experience or perception of an event is enhanced by a virtual representation of the event. In particular, the technique uses a portable electronic device, such as a mobile telephone, to enhance the user's auditory perception of an event that is associated with a sound, but where the user may be too far away from the source of the sound to hear the sound as it is generated by the source. Following the auditory perception of the event, the user may take appropriate responsive action.

In one embodiment, the user may set a sound producing device to send a notice to the user's electronic device when the sound-generating event has occurred. The notice may be a message, or other data object, that is transmitted through a network. Upon receipt of the notice, the electronic device may play back an audio file that contains sound data representative of the sound-generating event. Additional exemplary details of the sound representing technique will be described in the following detailed description section.

According to one aspect of the disclosure, a method of representing an event that is associated with a sound to a user of a portable electronic device includes storing an audio file containing a representation of the sound in the portable electronic device; receiving a notice generated by a sound producing device that the event has occurred; and playing back the audio file.

According to one embodiment of the method, the sound producing device generates the sound upon occurrence of the event.

According to one embodiment of the method, the sound producing device detects the sound or the event from an associated object.

According to one embodiment of the method, the playback of the audio file provides an audio resemblance of the sound that is produced by the sound producing device in connection with the occurrence of the event.

According to one embodiment, the method further includes transferring an address for the notice from the portable electronic device to the sound producing device over a local interface established between the portable electronic device and the sound producing device.

According to one embodiment of the method, the notice is transmitted to the portable electronic device over a network.

According to one embodiment, the method further includes obtaining the audio file from the sound producing device.

According to one embodiment of the method, the portable electronic device is a mobile telephone.

According to another aspect of the disclosure, a portable electronic device that represents an event that is associated with a sound to a user includes a memory that stores an audio file containing a representation of the sound; a network interface over which the electronic device receives a notice generated by a sound producing device that the event has occurred; and a controller that controls play back of the audio file in response to receipt of the notice.

According to one embodiment of the portable electronic device, the sound producing device generates the sound upon the occurrence of the event.

According to one embodiment of the portable electronic device, the sound producing device detects the sound or the event from an associated object.

According to one embodiment of the portable electronic device, the playback of the audio file provides an audio resemblance of the sound that is produced by the sound producing device in connection with the occurrence of the event.

According to one embodiment, the portable electronic device further includes a local interface used to transfers an address for the notice from the portable electronic device to the sound producing device.

According to one embodiment of the portable electronic device, the portable electronic device is a mobile telephone.

According to another aspect of the disclosure, a method of representing an event that is associated with a sound to a user of a portable electronic device includes receiving an address for the portable electronic device using a sound producing device; and detecting the event or the sound with the sound producing device; and transmitting a notice from the sound producing device to the portable electronic device indicating that the event has occurred, the notice for invoking playback of an audio file that is associated with the event and stored in the portable electronic device.

According to one embodiment of the method, the sound producing device generates the sound upon the occurrence of the event.

According to one embodiment of the method, the sound producing device detects the sound or the event from an associated object.

According to one embodiment of the method, the playback of the audio file provides an audio resemblance of the sound that is produced by the sound producing device in connection with the occurrence of the event.

According to still another aspect of the disclosure, a sound producing device that notifies a portable electronic device of an event that is associated with a sound includes a controller that detects the event or the sound and generates a notice; and a network interface over which the notice is transmitted to the portable electronic device for invoking playback of an audio file that is associated with the event and stored in the portable electronic device.

According to one embodiment of the sound producing device, the sound producing device generates the sound upon the occurrence of the event.

According to one embodiment of the sound producing device, the sound producing device detects the sound or the event from an associated object.

According to one embodiment of the sound producing device, the playback of the audio file provides an audio resemblance of the sound that is produced by the sound producing device in connection with the occurrence of the event.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of a communication system that includes a sound producing device and a portable electronic device that plays back an audio representation of a sound associated with an event involving the sound producing device;

FIG. 2 is a schematic functional block diagram of the electronic device of FIG. 1;

FIG. 3 is a flow chart representing steps carried out by the electronic device of FIG. 1 to implement an exemplary method of playing back an audio representation of the sound associated with the event involving the sound producing device of FIG. 1; and

FIG. 4 is a flow chart representing steps carried out by the sound producing device of FIG. 1 to implement the exemplary method of playing back an audio representation of the sound associated with the event involving the sound producing device.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a communicator, an electronic organizer, a personal digital assistant (PDA), a smartphone, a portable communication apparatus, etc.

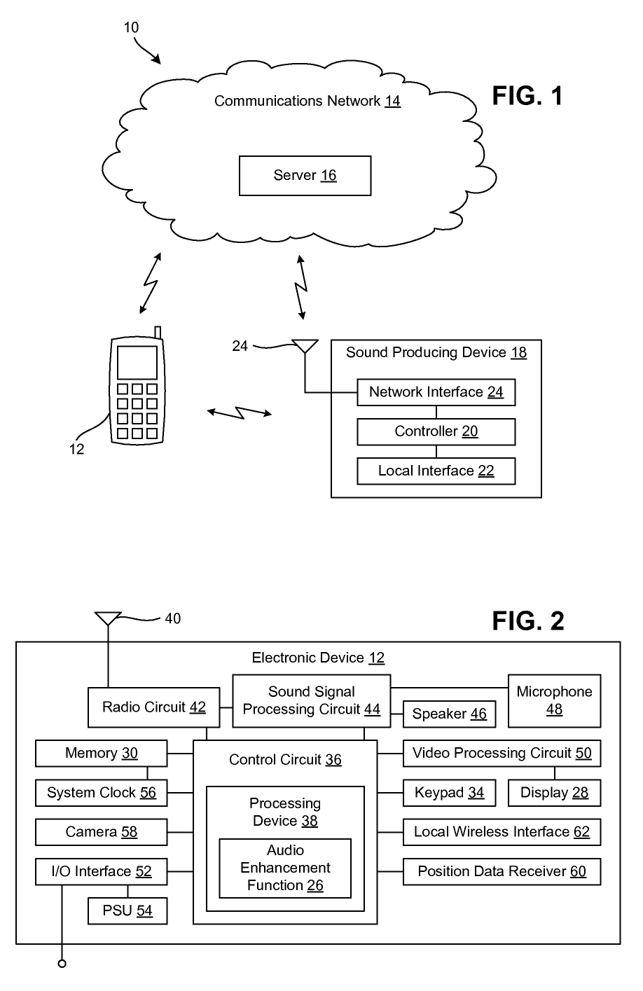

Initially referring to FIG. 1, illustrated is a representative communication system 10 in which an electronic device 12 is configured to operate. The system 10 may include a communications network 14 having a server 16 (or servers) for managing calls placed by and destined to the electronic device 12, transmitting data to the electronic device 12 and/or carrying out any other support functions. The server 16 communicates with the electronic device 12 via a transmission medium. The transmission medium may be any appropriate device or assembly, including, for example, a communications base station (e.g., a cellular service tower, or “cell” tower), a wireless access point, a satellite, etc. The network 14 may support the communications activity of multiple electronic devices 12 and other types of end user devices. As will be appreciated, the server 16 may be configured as a typical computer system used to carry out server functions and may include a processor configured to execute software containing logical instructions that embody the functions of the server 16 and a memory to store such software.

A sound producing device 18 (or sound notifying device) also may be configured to operate as part of the communication system 10. The sound producing device 18 may produce a sound in connection with an event. Exemplary sound producing devices 18 may include, but are not limited to appliances (e.g., microwave ovens, convection ovens, toaster ovens, pop-up toasters, dishwashers, refrigerators, clothes washers, clothes dryers, etc.), computers, vehicles (e.g., passenger cars and trucks), a telephone (e.g., a conventional residential phone operating over a plain old telephone system, or POTS), and so forth. In other situations, the sound producing device may be a combination of an item and a sensor unit, where the sensor unit detects sound, movement or position of the item and transmits a corresponding notice to the electronic device 12. Non-exhaustive examples of this alternative type of sound producing device include a baby and a baby monitor, a door and a door opening sensor (e.g., a sensor as might be found in an alarm system), and any one of the foregoing sound producing devices and a sensor unit configured to detect the associated sound(s) and transmit a corresponding notice to the electronic device 12.

The sound producing device 18 may include a controller 20 that controls operation of the sound producing device 18 so as to interface with the electronic device 12 to implement a technique of audibly notifying a user of an event associated with the sound producing device 18. The controller 20 may be dedicated to this function or may be involved with other operations of the sound producing device 18 (e.g., in the case of an appliance, the controller 20 also may control operation of the appliance). The controller 20 may be implemented as an arrangement of dedicated circuit components, a circuit that stores and executes firmware, a processor that executes logical instructions in the form of code (e.g., software) and an associated memory for storing such code, or combinations of these embodiments.

To interface directly with the electronic device 12, the sound producing device 18 may include a local interface 22. The local interface 22 may be any local wireless interface (e.g., a radio frequency (RF) interface or infrared (IR) interface) or a physical interface to establish a wired connection (e.g., a universal serial bus (USB) interface or other input/output (I/O) interface). In one embodiment, the local interface 22 employs any appropriate near field communication technique, such as by using a near field communication (NFC) chipset or other similar apparatus (e.g., a radio frequency identification (RFID) transponder). In another embodiment, the local interface 22 may be an RF networking interface, such as a Bluetooth interface.

The sound producing device 18 also may include a network interface 24 to establish communications with the communications network 14. For instance, the network interface 24 may be a wireless local area network (LAN) adapter, such as an IEEE 802.11 (“WiFi”) transceiver, an IEEE 802.16 (“WiMax”) transceiver, a radio circuit for establishing communication with a cellular carrier, and so forth. In the illustrated embodiment, the communication between the sound producing device 18 and the communication network 14 is wireless. It will be appreciated that this interface may be wired interface, such an Ethernet connection.

With additional reference to FIG. 2, additional details of the electronic device 12, when configured in the exemplary embodiment as a mobile telephone, will be described. The electronic device 12 may include an audio enhancement function 26 that is configured to audibly communicate an event associated with the sound producing device 18 to a user of the electronic device 12. Additional details and operation of the audio enhancement function 26 will be described in greater detail below. The audio enhancement function 26 may be embodied as executable code that is resident in and executed by the electronic device 12. In one embodiment, the audio enhancement function 26 may be a program stored on a computer or machine readable medium. The audio enhancement function 26 may be a stand-alone software application or form a part of a software application that carries out additional tasks related to the electronic device 12.

The electronic device 12 may include a display 28. The display 28 displays information to a user such as operating state, time, telephone numbers, contact information, various menus, etc., that enable the user to utilize the various features of the electronic device 12. The display 28 also may be used to visually display content received by the electronic device 12 and/or retrieved from a memory 30 of the electronic device 12. The display 28 may be used to present images, video and other graphics to the user, such as photographs, mobile television content and video associated with games.

A keypad 34 provides for a variety of user input operations. For example, the keypad 34 may include alphanumeric keys for allowing entry of alphanumeric information such as telephone numbers, phone lists, contact information, notes, text, etc. In addition, the keypad 34 may include special function keys such as a “call send” key for initiating or answering a call, and a “call end” key for ending or “hanging up” a call. Special function keys also may include menu navigation and select keys to facilitate navigating through a menu displayed on the display 28. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 28. Also, the display 28 and keypad 34 may be used in conjunction with one another to implement soft key functionality.

The electronic device 12 includes call circuitry that enables the electronic device 12 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 12 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), Internet content, and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 16, executing applications to allow user interaction with the data, displaying video and/or image content associated with the data, outputting audio sounds associated with the data, and so forth.

The electronic device 12 includes a primary control circuit 36 that is configured to carry out overall control of the functions and operations of the electronic device 12. The control circuit 36 may include a processing device 38, such as a central processing unit (CPU), microcontroller or microprocessor. The processing device 38 executes code stored in a memory (not shown) within the control circuit 36 and/or in a separate memory, such as the memory 30, in order to carry out operation of the electronic device 12. The memory 30 may be, for example, one or more of a buffer, a flash memory, a hard drive, a removable media, a volatile memory, a non-volatile memory, a random access memory (RAM), or other suitable device. In a typical arrangement, the memory 30 may include a non-volatile memory (e.g., a NAND or NOR architecture flash memory) for long term data storage and a volatile memory that functions as system memory for the control circuit 36. The volatile memory may be a RAM implemented with synchronous dynamic random access memory (SDRAM), for example. The memory 30 may exchange data with the control circuit 36 over a data bus. Accompanying control lines and an address bus between the memory 30 and the control circuit 36 also may be present.

In addition, the processing device 38 may execute code that implements the audio enhancement function 26. It will be apparent to a person having ordinary skill in the art of computer programming, and specifically in application programming for mobile telephones or other electronic devices, how to program a electronic device 12 to operate and carry out logical functions associated with the audio enhancement function 26. Accordingly, details as to specific programming code have been left out for the sake of brevity. Also, while the audio enhancement function 26 is executed by the processing device 38 in accordance with an embodiment, such functionality could also be carried out via dedicated hardware or firmware, or some combination of hardware, firmware and/or software.

The electronic device 12 includes an antenna 40 coupled to a radio circuit 42. The radio circuit 42 includes a radio frequency transmitter and receiver for transmitting and receiving signals via the antenna 40. The radio circuit 42 may be configured to operate in the communications system 10 and may be used to send and receive data and/or audiovisual content via the network 14. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 40 and the radio circuit 42 may represent one or more than one radio transceiver.

The electronic device 12 further includes a sound signal processing circuit 44 for processing audio signals transmitted by and received from the radio circuit 42. Coupled to the sound processing circuit 44 are a speaker 46 and a microphone 48 that enable a user to listen and speak via the electronic device 12. The radio circuit 42 and sound processing circuit 44 are each coupled to the control circuit 36 so as to carry out overall operation. Audio data may be passed from the control circuit 36 to the sound signal processing circuit 44 for playback to the user. The audio data may include, for example, audio data from an audio file stored by the memory 30 and retrieved by the control circuit 36, or received audio data such as in the form of streaming audio data from a mobile radio service. The sound processing circuit 44 may include any appropriate buffers, decoders, amplifiers and so forth.

The display 28 may be coupled to the control circuit 36 by a video processing circuit 50 that converts video data to a video signal used to drive the display 28. The video processing circuit 50 may include any appropriate buffers, decoders, video data processors and so forth. The video data may be generated by the control circuit 36, retrieved from a video file that is stored in the memory 30, derived from an incoming video data stream that is received by the radio circuit 42 or obtained by any other suitable method.

The electronic device 12 may further include one or more I/O interface(s) 52. The I/O interface(s) 52 may be in the form of typical mobile telephone I/O interfaces and may include one or more electrical connectors. As is typical, the I/O interface(s) 52 may be used to couple the electronic device 12 to a battery charger to charge a battery of a power supply unit (PSU) 54 within the electronic device 12. In addition, or in the alternative, the I/O interface(s) 52 may serve to connect the electronic device 12 to a headset assembly (e.g., a personal handsfree (PHF) device) that has a wired interface with the electronic device 12. Further, the I/O interface(s) 52 may serve to connect the electronic device 12 to a personal computer or other device via a data cable for the exchange of data. The electronic device 12 may receive operating power via the I/O interface(s) 52 when connected to a vehicle power adapter or an electricity outlet power adapter. The PSU 54 may supply power to operate the electronic device 12 in the absence of an external power source.

The electronic device 12 also may include a system clock 56 for clocking the various components of the electronic device 12, such as the control circuit 36 and the memory 30.

The electronic device 12 may include a camera 58 for taking digital pictures and/or movies. Image and/or video files corresponding to the pictures and/or movies may be stored in the memory 30.

The electronic device 12 also may include a position data receiver 60, such as a global positioning system (GPS) receiver, Galileo satellite system receiver or the like. The position data receiver 60 may be involved in determining the location of the electronic device 12.

The electronic device 12 also may include a local wireless interface 62, such as an IR transceiver and/or an RF interface, for establishing communication with an accessory, another mobile radio terminal, a computer or another device. Exemplary wireless interfaces 62 include a Bluetooth interface, an NFC chipset, an RFID transponder, etc. For example, the local wireless interface 62 may operatively couple the electronic device 12 to a headset assembly (e.g., a PHF device) in an embodiment where the headset assembly has a corresponding wireless interface.

The electronic device 12 may communicate with the sound producing device 18 over a communication link established between the local interface 22 of the sound producing device 18 and one of the local wireless interface 62 or the I/O interface 52 of the electronic device 12. Also, the electronic device 12 may communication with the sound processing device 18 through the network 14.

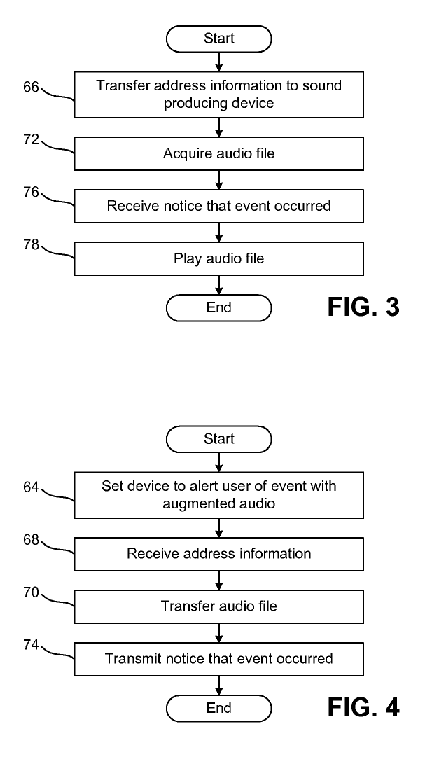

With additional reference to FIGS. 3 and 4, illustrated are logical operations to implement an exemplary method of playing back an audio representation of a sound associated with an event involving the sound producing device 18. FIG. 3 represents exemplary steps that may be carried out by the electronic device 12 and FIG. 4 represents exemplary steps that may be carried out by the sound producing device 18. The steps of the exemplary method that are carried out by the electronic device 12 may be effectuated by, for example, executing an embodiment of the audio enhancement function 26. Thus, the flow chart of FIG. 3 may be thought of as depicting steps of a method carried out by the electronic device 12 and the flowchart of FIG. 4 may be thought of as depicting steps of a method carried out by the sound producing device 18 (e.g., as carried out by the controller 20 and/or other components of the sound producing device 18). Although FIGS. 3 and 4 show a specific order of executing functional logic blocks, the order of executing the blocks may be changed relative to the order shown or described. Also, two or more blocks shown or described in succession may be executed concurrently or with partial concurrence. Certain blocks also may be omitted.

The logical flow may begin in block 64 (FIG. 4) where the user may set the sound producing device 18 to alert the user of an event associated with the sound producing device 18 using the augmented audio approach of playing back an audio file with the electronic device 12. Setting the sound producing device 18 may include depressing a button, setting a menu option, or some other user action. In another embodiment, setting the sound producing device 18 may be carried out by establishing a local interface between the electronic device 12 and the sound producing device 18 using the local interface 22. For instance, an exchange of information using NFC chipsets in the respective devices may set the sound producing device 18 to send a notice to the electronic device 12 when an event occurs. In other embodiments, the sound producing device 18 may be set to carry out the alert operation by default.

Each sound producing device may have different events that are associated with a sound for which the method may be employed. Exemplary events and associated sounds for representative appliances may include, by are not limited to, “beeping” of a microwave oven when a cook cycle is complete, “beeping” of a conventional oven when a pre-heat temperature is reached or when a timer expires, ringing of a bell when a toaster oven completes a timed toast operation, the sound of a pop-up toaster when a toasting operation is complete, the sound of ice falling from an ice maker into a storage area, and the “buzzing” of a clothes dryer when a drying cycle is complete. Other events may include the completion of a computer-related task, such as the completion of a software installation, the completion of a file download, and so forth. Other events may relate to a vehicle, such as the starting of an engine or the triggering of a car alarm. Other events may be the ringing of a conventional POTS telephone or a VoIP call received by a desktop computer. Other examples of events may include the crying of a baby, the opening or closing of a door, and so forth. Still other events may be a transition from making sound to not making sound, such as the conclusion of wash and rinse cycles of a dishwashing machine, or the conclusion of a spin cycle of a clothes washer. Therefore, the event may be characterized by the relative absence of sound.

Information regarding the electronic device 12 may be transferred to the sound producing device 18 so that a notice of the event may be transmitted to the electronic device 12. For instance, in block 66 (FIG. 3), using an interface established between the electronic device 12 and the sound producing device 18, the electronic device 12 may transmit an address of the electronic device 12 to the sound producing device 18. The sound producing device 18 may receive the address information in block 68 (FIG. 4). The address may be, for example a local subnet or global Internet protocol (IP) address. In other embodiments, the address information may be an electronic mail address, a device identifier, a text message address, a telephone number, or some other value that may be used to transmit a notice uniquely to the electronic device 12.

In one embodiment, the transfer of the address information may be carried out over the local interface 22 of the sound producing device 22. For instance, if the local interface 22 is an NFC chipset, the electronic device 12 may communicate its address information using a compatible NFC chipset. As indicated, other local interfaces may include, but are not limited to, an IR interface, an RF interface (e.g., Bluetooth), a wired interface (e.g., USB) and so forth. Alternatively, the address information may be transmitted through the network 14. In another embodiment, the address information may be manually entered into the sound producing device 18 by the user.

In block 70 (FIG. 4), the sound producing device 18 may transfer an audio file corresponding to the event to the electronic device 12. In block 72 (FIG. 3), the electronic device 12 may acquire the audio file corresponding to the event. The audio file may be played back by the electronic device 12 at some time in the future so as to represent to the user that the event has occurred. For instance, the audio file may contain a recording or a simulation of the sound that the sound producing device 18 makes when the event occurs. In other embodiments, the audio file may contain other audio content that has meaning to the user. For instance, instead of a recording or simulation of a clothes dryer buzzer, the audio file may contain audio data of a person saying “your clothes are dry.”

In one embodiment, the audio file may be transferred from the sound producing device 18 to the electronic device 12 using the interface that is established to transfer the address of the electronic device 12 to the sound producing device 18. Therefore, the audio file may be obtained by the electronic device 12 in an exchange with the sound producing device 18. For instance, audio data may stored in an NFC tag of the sound producing device 18 and, upon receipt by the electronic device 12, the audio data may be stored in the memory 30 as an audio file. In another embodiment, an audio file may be downloaded from the server 16 or obtained by another file transfer means. Therefore, the audio file need not originate from the sound producing device 18. In another embodiment, the audio file may be transferred as part of the below-described notice that indicates to the electronic device 12 that the event has occurred. In another embodiment, the electronic device 12 may record a sound from the sound producing device 18 at a time when the electronic device 12 is in the proximity of the sound producing device 18 to generate an audio file for future use. Upon receipt of the audio file, the audio file may be stored in the memory 30 of the electronic device 12 for future playback to the user. Also, the audio data may have been stored from previous execution of the method. In some embodiments, storing of an audio file or audio data representing the sound may include buffering of the audio file or audio data.

When the event occurs, in block 74 (FIG. 4), the sound producing device 18 may transmit a notice to the electronic device 12 that the event has occurred. The occurrence of the event may be detected by the sound producing device 18 by any appropriate technique. For instance, the controller 20 may be aware of an operational state (e.g., a programmed condition) or mode of the sound producing device 18 and a change in the state or mode may be indicative of the event. In other situations, mechanical action or the toggling of switch may result in an electrical signal or condition that may be sensed by the controller 20 of the sound producing device 18. In other situations, a microphone or other sensor may sense sound relating to the event and input a corresponding signal to the controller 20 for generation of the notice.

The notice may be received by the electronic device 12 in block 76 (FIG. 3). The notice may be transmitted via the network 14, for example. The notice may be in the form of a data object, such as specialized message addressed to the electronic device 12. Alternative, the data object may be in the form of an electronic mail message, a text message, a multimedia message, one or more push-delivered data packet, and so forth.

The data object forming the notice may be tagged for recognition by the audio enhancement function 26 so that, upon receipt of the notice and in block 78, the electronic device 12 plays the audio file through the speaker 46 or a connected PHF device. The playback of the audio file may alert the user to the fact that the event has occurred, even if the user is located remotely from the sound producing device 18 so that the user may not directly hear the sound that is ordinarily associated with the event and produced directly by the sound producing device 18.

In one embodiment, the technique may be modified to include video playback of a video file that represents the event. For instance, in the example of a pop-up toaster, the electronic device 12 may acquire a video file that contains a video of toast popping up from a toaster. Upon receipt of the notice that the event occurred, the video file may be played. The video file may include an audio component so as to both visually and audibly represent the event.

As will be appreciated, the foregoing describes a technique for at least audibly representing an event associated with a sound. The representation may be made in a location that is remote from the vicinity of the event where the associated sound is ordinarily audible directly from the source of the sound. Instead of transmitting actual audio content of event to the electronic device 10, a signal (e.g., the above-described notice) indicating the occurrence of the event is sent. When the signal is received, the electronic device 12 plays back a previously stored (or then received) recording, likeness or representation of the audible event so that the user may perceive the occurrence of the event. The user may then take a desired action in response.

The technique is illustrated by the following simple, household-related example. The user may put a food item in an oven, toaster, microwave, or similar appliance and sets the device to cook the food item. The user would like to know as soon as the cooking cycle is complete, but does not want to wait near the cooking device until the task is done. The user may indicate, when initiating the task, that he or she would like to have a notification sent to the user's electronic device 12 when the task (e.g., cooking the food) is done. Address information for the electronic device 12 may be input to the sound producing device 12.

Once the event occurs (e.g., the toaster pops up or the microwave beeps), the appliance of the example sends a notification to the electronic device 12 at the provided address. The electronic device 12 responds by playing the audible representation of the event (e.g., a toaster popping sound or a distinctive microwave beep) as contained in the corresponding audio file. The result of playing back the audio data from the audio file may be to extend the effective audible range of the event and to give the user the perception that he or she is in the vicinity of the sound producing device 18 at the time of the event.

Another example is the drying of laundry with a clothes dryer. Often, a person will put wet clothes from a clothes washer into a dryer, turn the dryer on, and go to another location. For instance, the dryer may be in a basement or on a second floor. After putting the clothes in the dryer, the person may go to the garage or outside in an adjacent yard to attend to another task. The sound that the dryer ordinarily makes when a drying cycle is complete may not be audible in this alternative location. Therefore, even if the person sets a buzzer on the dryer to go off, he or she would like to know when the laundry is finished in order to retrieve the clothes from the dryer (e.g., to keep them from wrinkling) and/or to put another load of wet clothes in the dryer. Using the above-described techniques, the electronic device 12 may use an audio representation of the event (e.g., the sounding of a dryer buzzer in the example) to notify the user that the event has occurred.

An advantage of the approach of playing an audio representation of the event (e.g., audio content that itself is indicative of the event) compared to simply sending a text message notification upon completion of an event is that the user need not view the notification on the display 28. While receipt of a text message or other type of message may be associated with an audible output from the electronic device, the audible output is not directly indicative of the event. Instead, under the described approach, the user audibly perceives the event in the same or similar manner as if the user were within the audible range of the sound producing device 18 at the time of the event.

Although certain embodiments have been shown and described, it is understood that equivalents and modifications falling within the scope of the appended claims will occur to others who are skilled in the art upon the reading and understanding of this specification.

What is claimed is:

1. A method of representing an event that is associated with a sound to a user of a portable electronic device, comprising:
storing an audio file containing a representation of the sound in the portable electronic device;
receiving a notice generated by a sound producing device that the event has occurred; and
playing back the audio file.

2. The method of claim 1, wherein the sound producing device generates the sound upon occurrence of the event.

3. The method of claim 1, wherein the sound producing device detects the sound or the event from an associated object.

4. The method of claim 1, wherein the playback of the audio file provides an audio resemblance of the sound that is produced by the sound producing device in connection with the occurrence of the event.

5. The method of claim 1, further comprising transferring an address for the notice from the portable electronic device to the sound producing device over a local interface established between the portable electronic device and the sound producing device.

6. The method of claim 1, wherein the notice is transmitted to the portable electronic device over a network.

7. The method of claim 1, further comprising obtaining the audio file from the sound producing device.

8. The method of claim 1, wherein the portable electronic device is a mobile telephone.

9. A portable electronic device that represents an event that is associated with a sound to a user, comprising:
a memory that stores an audio file containing a representation of the sound;
a network interface over which the electronic device receives a notice generated by a sound producing device that the event has occurred; and
a controller that controls play back of the audio file in response to receipt of the notice.

10. The portable electronic device of claim 9, wherein the sound producing device generates the sound upon occurrence of the event.

11. The portable electronic device of claim 9, wherein the sound producing device detects the sound or the event from an associated object.

12. The portable electronic device of claim 9, wherein the playback of the audio file provides an audio resemblance of the sound that is produced by the sound producing device in connection with the occurrence of the event.

13. The portable electronic device of claim 9, further comprising a local interface used to transfer an address for the notice from the portable electronic device to the sound producing device.

14. The portable electronic device of claim 9, wherein the portable electronic device is a mobile telephone.

15. A method of representing an event that is associated with a sound to a user of a portable electronic device, comprising:
receiving an address for the portable electronic device using a sound producing device; and
detecting the event or the sound with the sound producing device; and
transmitting a notice from the sound producing device to the portable electronic device indicating that the event has occurred, the notice for invoking playback of an audio file that is associated with the event and stored in the portable electronic device.

16. The method of claim 15, wherein the sound producing device generates the sound upon occurrence of the event.

17. The method of claim 15, wherein the sound producing device detects the sound or the event from an associated object.

18. The method of claim 15, wherein the playback of the audio file provides an audio resemblance of the sound that is produced by the sound producing device in connection with the occurrence of the event.

19. A sound producing device that notifies a portable electronic device of an event that is associated with a sound, comprising:
a controller that detects the event or the sound and generates a notice; and
a network interface over which the notice is transmitted to the portable electronic device for invoking playback of an audio file that is associated with the event and stored in the portable electronic device.

20. The sound producing device of claim 19, wherein the sound producing device generates the sound upon occurrence of the event.

21. The sound producing device of claim 19, wherein the sound producing device detects the sound or the event from an associated object.

22. The sound producing device of claim 19, wherein the playback of the audio file provides an audio resemblance of the sound that is produced by the sound producing device in connection with the occurrence of the event.
